(19) United States
(12) Patent Application Publication
(10) Pub. No.: US 2026/0318697 A1
(43) Pub. Date: Oct. 15, 2026

(54) PATHFINDING DEVICE, SERVER DEVICE, ELECTRIC VEHICLE, PATHFINDING METHOD, AND STORAGE MEDIUM

(71) Applicant: HONDA MOTOR CO., LTD., Tokyo (JP)

(72) Inventor: Ryo Asai, Wako-shi (JP)

(21) Appl. No.: 19/565,597

(22) Filed: Mar. 13, 2026

(30) Foreign Application Priority Data
Mar. 28, 2025 (JP) 2025-055853

(51) Int. Cl. G01C 21/34

(52) U.S. Cl. CPC G01C 21/3469

(57) ABSTRACT

A pathfinding device shows the remaining battery power of an electric vehicle as the drivable time, shows the amount of charging energy at a charging node as an increase in the drivable time, and searches for a combination of edges that minimizes the value of an objective function under a constraint that the drivable time during the entire period from departure from a start node to arrival at a goal node is 0 or more.

### CROSS-REFERENCE TO RELATED APPLICATIONS

This application is based upon and claims the benefit of priority from Japanese Patent Application No. 2025-055853 filed on Mar. 28, 2025, the contents of which are incorporated herein by reference.

### BACKGROUND OF THE INVENTION

### Field of the Invention

The present disclosure relates to a pathfinding device, a server device, an electric vehicle, a pathfinding method, and a storage medium.

### Description of the Related Art

JP 2005-122679 A discloses a vehicle operation plan creation method. The vehicle operation plan creation method creates operation plans for vehicles that perform pickup operations at a plurality of delivery bases and delivery operations to a plurality of delivery destinations.

### SUMMARY OF THE INVENTION

A better pathfinding device and the like is awaited.

The present disclosure has the object of solving the aforementioned problem.

A first aspect of the present disclosure is a pathfinding device configured to search for a path along which an electric vehicle travels from a start point to a goal point using a graph including a plurality of nodes representing points and edges representing partial paths connecting two of the points, wherein the plurality of nodes constituting the graph include a start node representing the start point, a goal node representing the goal point, a work node presenting a point where work is performed, and a charging node representing a point where charging is performed for the electric vehicle, and a required time required for the electric vehicle to travel from a start to an end of a partial path of the partial paths is associated with each of the edges constituting the graph, and the pathfinding device including an acquisition unit configured to acquire the graph, a search unit configured to set an objective function that includes an outstanding work count indicating a total number of unused edges among the edges toward the work node included in the graph, and defines, as the path, a combination of partial paths corresponding to a combination of edges that minimizes a value of the objective function among combinations of edges used from the start node to the goal node, wherein the search unit shows the remaining battery power of the electric vehicle as a drivable time, shows an amount of charging energy at the charging node as an increase in the drivable time, and searches for the combination of edges that minimizes a value of the objective function under a constraint that the drivable time in the entire period from the start node to the goal node is greater than or equal to zero.

A second aspect of the present disclosure is a server device in an information processing system including an electric vehicle and the server device configured to communicate with the electric vehicle, the server device including the pathfinding device according to the first aspect.

A third aspect of the present disclosure is an electric vehicle including the pathfinding device according to the first aspect.

A fourth aspect of the present disclosure is a pathfinding method for searching a path along which an electric vehicle travels from a start point to a goal point using a graph including a plurality of nodes representing points and edges representing partial paths connecting two of the points, wherein the plurality of nodes constituting the graph include a start node representing the start point, a goal node representing the goal point, a work node representing a point where work is performed, and a charging node representing a point where charging is performed for the electric vehicle, and a required time required for the electric vehicle to travel from the start to the end of a partial path of the partial paths is associated with each of the edges constituting the graph, the pathfinding method comprising: acquiring the graph; showing remaining battery power of the electric vehicle as a drivable time; showing an amount of charging energy at the charging node as an increase in the drivable time; setting an objective function that includes an outstanding work count indicating a total number of unused edges among the edges toward the work node included in the graph; and among the combinations of the edges of the graph used from the start node to the goal node, setting, as the path, a combination of the partial paths corresponding to a combination of the edges that minimizes a value of the objective function under a constraint that the drivable time during the entire period from the start node to the goal node is greater than or equal to zero.

A fifth aspect of the present disclosure is a program for causing a computer to execute the pathfinding method according to the fourth aspect.

A sixth aspect of the present disclosure is a computer-readable non-transitory storage medium storing the program according to the fifth aspect.

According to the present disclosure, a better pathfinding device and the like can be provided.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram showing the configuration of an operation management system in one embodiment;

FIG. 2 is a block diagram showing a pathfinding device in the embodiment;

FIG. 3 is a diagram showing an example of map information stored in a map database; and

FIG. 4 is a diagram showing an example of an edge used for a vehicle.

### DETAILED DESCRIPTION OF THE INVENTION

When searching for a route along which an electric vehicle travels from a start point to a goal point while performing work at each point, it is necessary to search for a route in which a charging plan for charging the electric vehicle on the way is incorporated into a work plan so that the remaining battery power of the electric vehicle does not become zero during the travel.

By treating the work plan and the charging plan as one optimization problem, a pathfinding device of the present disclosure can find an efficient route taking the work plan and the charging plan into consideration.

### Embodiment

### [Operation Control System]

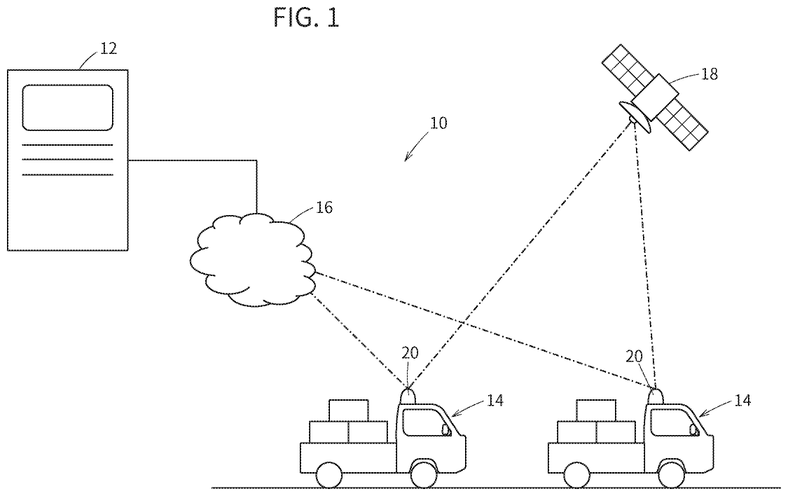

FIG. 1 is a schematic diagram showing the configuration of an operation management system 10 in one embodiment. The operation management system 10 corresponds to an information processing system of the present invention. The operation management system 10 includes a server device 12 and a plurality of electric vehicles 14. The server device 12 and an electric vehicle 14 can communicate with each other via a network 16 such as the Internet.

The electric vehicle 14 is an autonomously movable vehicle. The electric vehicle 14 performs, for example, cargo handling. The electric vehicle 14 may be the one for performing grass cutting, tillage, or the like.

The electric vehicle 14 is equipped with a GNSS (Global Navigation Satellite System) receiver 20 that receives signals from a GNSS satellite 18. The GNSS receiver 20 calculates the position of the electric vehicle 14 based on the signals received from the GNSS satellite 18.

### [Pathfinding Device]

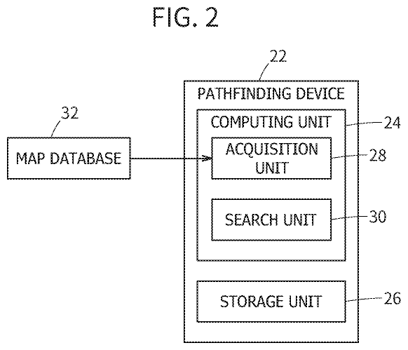

FIG. 2 is a block diagram showing a pathfinding device 22 in the embodiment. The pathfinding device 22 is mounted on the server device 12. The pathfinding device 22 may be mounted on the electric vehicle 14.

The pathfinding device 22 has a computing unit 24 and a storage unit 26. The computing unit 24 is a processor such as a CPU (Central Processing Unit) or a GPU (Graphics Processing Unit). The computing unit 24 includes an acquisition unit 28 and a search unit 30. The acquisition unit 28 and the search unit 30 are realized by the computing unit 24 executing programs stored in the storage unit 26. At least part of the acquisition unit 28 and the search unit 30 may be realized by an integrated circuit such as an ASIC (Application Specific Integrated Circuit) or an FPGA (Field-Programmable Gate Array). At least part of the acquisition unit 28 and the search unit 30 may be realized by an electronic circuit including discrete devices.

The storage unit 26 is a computer-readable non-transitory tangible storage medium. The storage unit 26 is constituted by a volatile memory (not shown) and a non-volatile memory (not shown). The volatile memory is, for example, a RAM (Random Access Memory) or the like. The nonvolatile memory is, for example, a ROM (Read Only Memory), a flash memory, or the like. Data and so on are stored, for example, in the volatile memory. Programs, tables, maps, and so on are stored, for example, in the non-volatile memory. At least part of the storage unit 26 may be provided in the above-described processor, integrated circuit, or the like. At least part of the storage unit 26 may be mounted on a device connected to the pathfinding device 22 through a network.

The acquisition unit 28 acquires from a map database 32 a graph constituting map information. The search unit 30 searches for a path along which the electric vehicle 14 travels from the start point to the goal point using a graph.

### [Map Information]

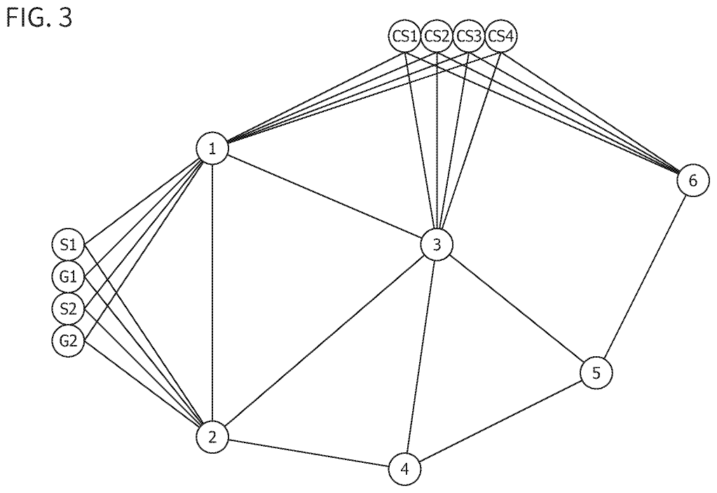

FIG. 3 is a diagram showing an example of map information stored in the map database 32. The map information is used in searching for a path that the electric vehicle 14 will take from the starting point to the target point. In the following, a path connecting points may be referred to as a partial path. Also, the entire partial path used to reach the target point from the starting point may be referred to as a path.

The map information is represented by a graph composed of multiple nodes and multiple edges. Nodes indicate points whereas edges indicate partial paths. Each edge is associated with a cost incurred by using the edge. In the map information of the present embodiment, the time required for the electric vehicle 14 to travel from the start to the end of the partial path corresponding to the edge is taken as the cost.

Nodes S1 and S2 in FIG. 3 are start nodes indicating start points of the electric vehicle 14. Nodes G1 and G2 in FIG. 3 are goal nodes indicating goal points of the electric vehicle 14. Nodes CS1 to CS4 in FIG. 3 are charging nodes that charge the electric vehicle 14. Nodes 1 to 6 in FIG. 3 are work nodes where the electric vehicle 14 performs work. The work nodes include a loading node where the electric vehicle 14 performs loading work and an unloading node where the electric vehicle 14 performs unloading work.

### [Search Unit]

The search unit 30 searches for a path based on a mathematical model described below. In the explanation of the mathematical model, one electric vehicle 14 may be referred to as a vehicle m. The electric vehicle 14, which is separate from the vehicle m, may be referred to as a vehicle m′. A vehicle m with an identifier “1” may be referred to as a vehicle 1. Edge (i, j) indicates an edge from node i to node j.

### (Index Set)

An index set used in the mathematical model is shown below.
[symbol] ⊂ [symbol] : Index set of vehicles
[symbol] ⊂ [symbol] : Index set of nodes
N^{load}⊂N: Index set of loading nodes
N^{unload}⊂N: Index set of unloading nodes
N^{charge}⊂N: Index set of charging nodes

### (Objective Function)

The search unit 30 searches for a path that minimizes the value of the following objective function. The variables used in the objective function are detailed later.

$$min α {\sum }_{i ∈ {𝒩}^{unload}} ( 1 - {\sum }_{m ∈ ℳ} {\sum }_{j ∈ 𝒩} {x}_{ji}^{m} ) + β {\sum }_{m ∈ ℳ} {\sum }_{i ∈ 𝒩} {\sum }_{j ∈ 𝒩} {t}_{ij} {x}_{ij}^{m} + γ {\sum }_{i ∈ 𝒩} {p}_{i}$$

The first term of the objective function denotes the number of outstanding jobs. The first term is provided to minimize the number of uncompleted jobs. A job is completed when the load loaded on the vehicle m at the loading nodes is unloaded from the vehicle m at the unloading nodes. Therefore, the number of outstanding jobs is defined by the number of edges not used by the vehicle m among the edges toward the unloading nodes. The number of outstanding jobs corresponds to an outstanding work count in the present invention.

The second term of the objective function denotes the total edge cost. The second term is provided to minimize the travel cost when going from the start node to the goal node via the work node. The travel cost includes time, fuel, energy, and so on. The total edge cost is specified by the sum of the costs associated with the edges that have been used by vehicle m. Minimizing the total edge cost enables efficient operation planning.

The third term of the objective function denotes the total arrival time. The arrival time of each node is indicated by the time elapsed from the time point when the vehicle m departs from the start node. The third term is provided to minimize the sum of arrival times of each node. Minimizing the total arrival time reduces the travel time of the electric vehicle 14 and enables efficient operation planning.

The “α” of the objective function denotes the weighting factor of the number of outstanding jobs, the “β” denotes the weighting factor of the total edge cost, and the “γ” denotes the weighting factor of the total arrival time. Each weighting factor is set to minimize the number of outstanding jobs, minimize the total edge cost, and minimize the total arrival time, in that order of priority.

### (Charger Modeling)

The nodes CS1 to CS4 in FIG. 3 are charging nodes, which model one charger. The charging nodes are treated in the same way as the loading and unloading nodes.

A single charger cannot charge multiple electric vehicles 14 simultaneously. Therefore, the system is designed so that each charging node charges the electric vehicle 14 only in a time slot set for each charging node. Further, the system is designed so that if a vehicle m has visited a charging node, another vehicle m′ cannot visit that charging node. These can be realized by setting constraints, which will be described later.

The period for making an operation plan is divided into certain time intervals, and a corresponding charging node(s) is set for each divided time interval. For example, it is assumed that the period for making an operation plan is 0 [sec] to 7200 [sec], and the period is divided every 1800 [sec]. In this case, the node CS1 in FIG. 3 is set as the charging node corresponding to the time slot from 0 [sec] to 1800 [sec]. The node CS2 in FIG. 3 is set as the charging node corresponding to the time slot from 1800 [sec] to 3600 [sec]. The node CS3 in FIG. 3 is set as the charging node corresponding to the time slot from 3600 [sec] to 5400 [sec]. The node CS4 in FIG. 3 is set as the charging node corresponding to the time slot from 5400 [sec] to 7200 [sec].

### (Decision Variable)

Decision variables used in the objective function are explained here.

A variable x indicating whether an edge has been used by vehicle m is given below. A value of “0” for the variable x indicates that the edge has been used by vehicle m whereas a value of “1” for the variable x indicates that the edge has not been used by vehicle m.

$${x}_{ij}^{m} ∈ \{ 0 , 1 \}$$

Whether a vehicle m∈ [symbol] has used an edge (i,j)∈ [symbol] × [symbol] or not

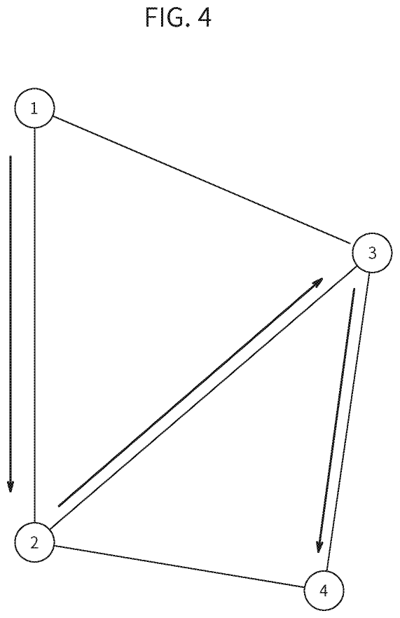

FIG. 4 is a diagram showing an example of an edge used for a vehicle m. FIG. 4 shows an example in which the vehicle 1 moves in the order of node 1, node 2, node 3, and node 4. In this case, the edges (1, 2), (2, 3), and (3, 4) are used by the vehicle 1 but the other edges are not used by the vehicle 1. In this case, the value of the variable x becomes as below.

$$\begin{matrix}{x}_{12}^{1} = {x}_{23}^{1} = {x}_{34}^{1} = 1 \\ {x}_{13}^{1} = {x}_{21}^{1} = {x}_{24}^{1} = {x}_{31}^{1} = {x}_{32}^{1} = {x}_{42}^{1} = {x}_{43}^{1} = 0\end{matrix}$$

The variable t, which denotes the cost of an edge, is shown below. The cost of an edge is indicated by the time required for the electric vehicle 14 to travel from the start point to the end point of the partial path corresponding to the edge.

tᵢⱼ∈ [symbol] : the cost of an edge (i,j)∈ [symbol] ×

[symbol]

The variable p indicating a work start time at the work nodes (loading node, unloading node, charging node) is shown below. The work start time indicates the time at which the electric vehicle 14 arrives at a work site.

pᵢ∈ [symbol] : a work start time at node i∈

[symbol]

### (Constraints)

The search unit 30 searches for a path under the following constraints. Constraints include conditions on paths, conditions on work, conditions on time, and conditions on batteries.

### <Condition on Path>

The following condition prescribes that a vehicle m arriving at node j depart from node j.

For all vehicles m and for all nodes i,

$${\sum }_{j ∈ 𝒩} {x}_{ij}^{m} - {\sum }_{j ∈ 𝒩} {x}_{ji}^{m} = 0 .$$

The following condition prescribes that a vehicle m departs from the start node of vehicle m only once and cannot reach the start node of vehicle m.

For all vehicles m and for the start nodes i∈ [symbol] of all vehicles m,

$${\sum }_{j ∈ 𝒩} {x}_{ij}^{m} = 1 ,$$

$${\sum }_{j ∈ 𝒩} {x}_{ji}^{m} = 0.$$

The following condition prescribes that a vehicle m arrives at the goal node of vehicle m only once and cannot depart from the goal node of vehicle m.

For all vehicles m and for the goal node i∈ [symbol] of all vehicles m,

$${\sum }_{j ∈ 𝒩} {x}_{ij}^{m} = 0 ,$$

$${\sum }_{j ∈ 𝒩} {x}_{ji}^{m} = 1.$$

The following condition prescribes that a vehicle m′, which is different from a vehicle m, cannot depart from the start node of the vehicle m and cannot arrive at the start node of the vehicle m.

For the start nodes i∈ [symbol] of all vehicles m,

$${\sum }_{{m}^{′} ∈ ℳ \backslash \{ m \}} {\sum }_{j ∈ 𝒩} {x}_{ij}^{{m}^{′}} = 0 ,$$

$${\sum }_{{m}^{′} ∈ ℳ \backslash \{ m \}} {\sum }_{j ∈ 𝒩} {x}_{ji}^{{m}^{′}} = 0.$$

The following condition prescribes that a vehicle m′, which is different from a vehicle m, cannot depart from the goal node of the vehicle m and cannot arrive at the goal node of the vehicle m.

For the goal nodes i∈ [symbol] of all the vehicles m,

$${\sum }_{{m}^{′} ∈ ℳ \backslash \{ m \}} {\sum }_{j ∈ 𝒩} {x}_{ij}^{{m}^{′}} = 0 ,$$

$${\sum }_{{m}^{′} ∈ ℳ \backslash \{ m \}} {\sum }_{j ∈ 𝒩} {x}_{ji}^{{m}^{′}} = 0.$$

The following condition prescribes that each node can be visited only once by any one vehicle m. For example, if the vehicle m visits a node i, a vehicle m′ cannot visit the node i. This formula allows us to prescribe that one charger cannot charge more than one electric vehicle 14 at the same time.

For all nodes i∈ [symbol] ,

$${\sum }_{m ∈ ℳ} {\sum }_{j ∈ 𝒩} {x}_{ij}^{m} \leq 1 .$$

### <Condition on Work>

The following condition prescribes that a vehicle m loaded with cargos at loading nodes unloads cargos at unloading nodes.

For all vehicles m and for combinations of the loading and unloading nodes (i^{load},i^{unload})∈ [symbol] × [symbol] of all the jobs,

$${\sum }_{j ∈ 𝒩} {x}_{{{i}^{{load}_{j}}}^{}}^{m} - {\sum }_{j ∈ 𝒩} {x}_{{{i}^{{unload}_{j}}}^{}}^{m} = 0.$$

### <Condition on Time>

The following condition prescribes a time slot for arrival at an unloading node. A time window is set for each unloading node, and the vehicle m can visit the unloading node only in the time slot indicated by the set time window.

There are Mᵢ time windows

$$[ {s}_{i}^{1} , {e}_{i}^{1} ] , … , [ {s}_{i}^{{M}_{i}} , {e}_{i}^{{M}_{i}} ]$$

for each of all the unloading nodes i, and

$${s}_{i}^{1} \leq {p}_{i} \leq {e}_{i}^{1} OR … OR {s}_{i}^{{M}_{i}} \leq {p}_{i} \leq {e}_{i}^{{M}_{i}} .$$

The following condition prescribes that a vehicle m visits an unloading node after visiting a loading node.

For the combination of loading and unloading nodes (i^{load},j^{unload})∈ [symbol] × [symbol] of all the jobs,

pᵢ_{^{load}}+tᵢ_{^{load}}ⱼ_{^{unload}}≤pᵢ_{^{unload}}.

The following condition prescribes that a vehicle m arrives at the goal node after departing from the start node.

For the combination of the start and goal nodes (i^{start},i^{goal})∈ [symbol] × [symbol] of all the vehicles m,

pᵢ_{^{start}}+tᵢ_{^{start}}ᵢ_{^{goal}}≤pᵢ_{^{goal}}.

The following condition prescribes the relationship between the time at which a vehicle m arrives at the start node of the edge and the time at which the electric vehicle 14 arrives at the end node of the edge.

For all edges (i,j)∈ [symbol] × [symbol] ,

$${p}_{i} + {T}_{i} + {t}_{ij} \leq {p}_{j} if {\sum }_{m ∈ ℳ} {x}_{ij}^{m} = 1$$

where Tᵢ∈ [symbol] is a working time (loading working time, unloading working time, charging time) at a node i∈ [symbol] .

### <Condition on Battery>

The following condition prescribes the change in the remaining battery power of a vehicle m. The remaining battery power is indicated by a drivable time of the electric vehicle 14. The amount of charging energy of the electric vehicle 14 is indicated by an increase in the drivable time of the electric vehicle 14. The remaining battery power of the electric vehicle 14 reduced by driving through the partial path corresponding to the edge is indicated by subtracting the cost associated with the used edge from the drivable time.

For all vehicles m and for any edge (i,j),

$${b}_{i}^{m} + {c}_{i} - {t}_{ij} = {b}_{j}^{m} if {x}_{ij}^{m} = 1$$

where cᵢ∈ [symbol] is the amount of charging energy at a node i∈ [symbol] , and
cᵢ>0 at a node i∈ [symbol] , and
cᵢ=0 at a node i∈ [symbol] \ [symbol] .

The following condition prescribes the lower limit of the remaining battery power of a vehicle m.

For all vehicles m and all nodes i;

$${b}_{i}^{m} \geq 0 .$$

The following formula prescribes the upper limit value of the remaining battery power of a vehicle m. The upper limit value of the remaining battery power indicates the battery capacity of the electric vehicle 14 and is indicated by the drivable time of the electric vehicle 14 when the SOC of the battery is 100%.

For all vehicles m and all nodes i,

$${b}_{i}^{m} \leq {C}^{m}$$

where C^{m} ∈ [symbol] is the battery capacity of a vehicle m.

The following condition prescribes the upper limit value of the amount of chargeable energy by one charger.

For a set of charging nodes

$${𝒩}_{k}^{charge}$$

indicating a charger k,

$${\sum }_{m ∈ ℳ} {\sum }_{i ∈ {𝒩}_{k}^{charge}} {\sum }_{j ∈ 𝒩} {c}_{i} {x}_{ij}^{m} \leq {C}^{k}$$

where C^{k}∈ [symbol] is the total rechargeable energy of a charger k.

The following condition prescribes an initial value of the remaining battery power of a vehicle m.

For a start node i^{start} of a vehicle m,

$${b}_{{i}^{start}}^{m} = {b}_{init}^{m} .$$

### (Pathfinding Algorithm)

The search unit 30 performs a Large Neighborhood Search (hereinafter, LNS) to perform pathfinding. The search unit 30 may perform pathfinding using an algorithm other than LNS.

LNS finds the optimal solution by repeatedly destroying (remove) and inserting (insert) a part of the current solution. LNS escapes local optima easily and is frequently used for a vehicle routing problem (VRP).

### [Benefits]

In the pathfinding device 22 of the present embodiment, an objective function is set including the number of outstanding jobs indicating the total number of unused edges among the edges toward the unloading nodes included in the graph. Furthermore, in the pathfinding device 22, the remaining battery power of the electric vehicle 14 is indicated by the drivable time. In the pathfinding device 22, the amount of charging energy at the charging node is indicated by an increase in the drivable time. In the pathfinding device 22, the remaining battery power of the electric vehicle 14 after using the edge is indicated by subtracting the required time associated with the used edge from the drivable time.

Under the constraint that the drivable time is equal to or greater than zero over the entire period from the departure from the start node to the arrival at the goal node, the search unit 30 sets, as a path, a combination of partial paths corresponding to a combination of edges with the minimum value of the objective function from among combinations of edges used from the departure from the start node to the arrival at the goal node.

Thus, it is possible to formulate the operation plan taking account of charging and work by incorporating the charging plan into the work plan and treating it as one optimization problem.

The objective function is represented by the sum of the number of outstanding jobs and the total edge cost, which is the sum of the required times associated with the used edges. This enables finding a path that makes the edge costs small and thus enables efficient operation planning.

The objective function is represented by the sum of the number of outstanding jobs, the total edge cost, and the total arrival time, which indicates the sum of arrival times. This makes it possible to obtain a route that shortens the operation time of the electric vehicle 14 and thus enables efficient operation planning.

Each charging node charges only one electric vehicle in a given time slot, and the given time slot of one charging node is a different time slot than a given time slot of another charging node. This allows us to prescribe that one charger does not charge more than one vehicle in the same time slot.

With respect to the above embodiments, the following supplementary notes are further disclosed.

### (Supplementary Note 1)

A pathfinding device (22) of the present disclosure configured to search for a path along which an electric vehicle (14) travels from a start point to a goal point using a graph including a plurality of nodes representing points and edges representing partial paths connecting two of the points, wherein the plurality of nodes constituting the graph include a start node representing the start point, a goal node representing the goal point, a work node presenting a point where work is performed, and a charging node representing a point where charging is performed for the electric vehicle, and a required time required for the electric vehicle to travel from a start to an end of a partial path of the partial paths is associated with each of the edges constituting the graph, and the pathfinding device including an acquisition unit (28) configured to acquire the graph, a search unit (30) configured to set an objective function that includes an outstanding work count indicating a total number of unused edges among the edges toward the work node included in the graph, and defines, as the path, a combination of partial paths corresponding to a combination of edges that minimizes a value of the objective function among combinations of edges used from the start node to the goal node, wherein the search unit shows the remaining battery power of the electric vehicle as a drivable time, shows an amount of charging energy at the charging node as an increase in the drivable time, and searches for the combination of edges that minimizes a value of the objective function under a constraint that the drivable time in the entire period from the start node to the goal node is greater than or equal to zero.

### (Supplementary Note 2)

In the pathfinding device according to Supplementary Note 1, the search unit may indicate the remaining battery power of the electric vehicle after the edges are used, by subtracting the required times associated with the used edges from the drivable time.

### (Supplementary Note 3)

In the pathfinding device according to the Supplementary Note 1, the objective function may be a sum of the outstanding work count and a total edge cost indicating a sum of the required times associated with the used edges.

### (Supplementary Note 4)

In the pathfinding device according to Supplementary Note 3, the search unit may calculate an arrival time, which is a time at which the electric vehicle arrives at the work node, and the objective function may be a sum of the outstanding work count, the total edge cost, and a total arrival time indicating a sum of the arrival times.

### (Supplementary Note 5)

In the pathfinding device described in Supplementary Note 1, each of the plurality of electric vehicles may search for the path to travel from the start point to the goal point, a plurality of charging nodes may be set for one point at which the plurality of the electric vehicles are charged, each of the charging nodes may charge only one of the electric vehicles in a predetermined time slot, and the predetermined time slot of one of the charging nodes may be a time slot different from the predetermined time slot of another of the charging nodes.

### (Supplementary Note 6)

A server device (12) of the present disclosure is a server device in an information processing system including an electric vehicle and the server device configured to communicate with the electric vehicle, the server device including the pathfinding device described in any one of Supplementary notes 1 to 5.

### (Supplementary Note 7)

An electric vehicle of the present disclosure includes the pathfinding device according to any one of Supplementary notes 1 to 5.

### (Supplementary Note 8)

A pathfinding method of the present disclosure is a method for searching a path along which an electric vehicle travels from a start point to a goal point using a graph including a plurality of nodes representing points and edges representing partial paths connecting two of the points, wherein the plurality of nodes constituting the graph include a start node representing the start point, a goal node representing the goal point, a work node representing a point where work is performed, and a charging node representing a point where charging is performed for the electric vehicle, and a required time required for the electric vehicle to travel from the start to the end of a partial path of the partial paths is associated with each of the edges constituting the graph, the pathfinding method comprising: acquiring the graph; showing remaining battery power of the electric vehicle as a drivable time; showing an amount of charging energy at the charging node as an increase in the drivable time; setting an objective function that includes an outstanding work count indicating a total number of unused edges among the edges toward the work node included in the graph; and among the combinations of the edges of the graph used from the start node to the goal node, setting, as the path, a combination of the partial paths corresponding to a combination of the edges that minimizes a value of the objective function under a constraint that the drivable time during the entire period from the start node to the goal node is greater than or equal to zero.

### (Supplementary Note 9)

In the pathfinding method according to Supplementary Note 8, the remaining battery power of the electric vehicle after the edges are used may be indicated by subtracting the required times associated with the used edges from the drivable time.

### (Supplementary Note 10)

In the pathfinding method according to the Supplementary Note 8, the objective function may be a sum of the outstanding work count and a total edge cost indicating a sum of the required times associated with the used edges.

### (Supplementary Note 11)

In the pathfinding method according to Supplementary Note 10, an arrival time may be calculated, which is a time at which the electric vehicle arrives at the work node, and the objective function may be a sum of the outstanding work count, the total edge cost, and a total arrival time indicating a sum of the arrival times.

### (Supplementary Note 12)

In the pathfinding method described in Supplementary Note 8, each of the plurality of electric vehicles may search for the path to travel from the start point to the goal point, a plurality of charging nodes may be set for one point at which the plurality of the electric vehicles are charged, each of the charging nodes may charge only one of the electric vehicles in a predetermined time slot, and the predetermined time slot of one of the charging nodes may be a time slot different from the predetermined time slot of another of the charging nodes.

### (Supplementary Note 13)

A program of the present disclosure causes a computer to execute the pathfinding method described in any one of Supplementary Notes 8 to 12.

### (Supplementary Note 14)

A computer-readable non-transitory storage medium of the present disclosure stores the program described in Supplementary Note 13.

Although concerning the present disclosure, a detailed description thereof has been presented above, the present disclosure is not necessarily limited to the individual embodiments described above. These embodiments may be subjected to various additions, substitutions, modifications, partial deletions and the like, within a range that does not deviate from the essence and gist of the present disclosure, or the spirit of the present disclosure as derived from the content described in the claims and equivalents thereof. Further, the embodiments can also be implemented together in combination. For example, in the above-described embodiments, the order of each of the operations and the order of each of the processes are illustrated as examples, and the present invention is not necessarily limited to these features. The same also applies to cases in which numerical values or mathematical expressions are used in the description of the aforementioned embodiments.

What is claimed is:

1. A pathfinding device configured to search for a path along which an electric vehicle travels from a start point to a goal point using a graph including a plurality of nodes representing points and edges representing partial paths each connecting two of the points, the pathfinding device comprising
one or more processors that execute computer-executable instructions stored in a memory,
wherein
the plurality of nodes constituting the graph include a start node representing the start point, a goal node representing the goal point, a work node representing a point where work is performed, and a charging node representing a point where charging is performed for the electric vehicle,
a required time required for the electric vehicle to travel from a start to an end of a partial path of the partial paths is associated with each of the edges constituting the graph, and
the one or more processors execute the computer-executable instructions to cause the pathfinding device to:
acquire the graph;
set an objective function that includes an outstanding work count indicating a total number of unused edges among the edges toward the work node included in the graph, and defines as the path a combination of the partial paths corresponding to a combination of the edges that minimizes a value of the objective function among combinations of the edges used from the start node to the goal node;
show remaining battery power of the electric vehicle as a drivable time;
show an amount of charging energy at the charging node as an increase in the drivable time; and
search for the combination of the edges that minimizes the value of the objective function under a constraint that the drivable time during an entire period from the start node to the goal node is greater than or equal to zero.

2. The pathfinding device according to claim 1, wherein
the one or more processors cause the pathfinding device to indicate the remaining battery power of the electric vehicle after the edges are used, by subtracting the required times associated with the used edges from the drivable time.

3. The pathfinding device according to claim 1, wherein
the objective function is a sum of the outstanding work count and a total edge cost indicating a sum of the required times associated with the used edges.

4. The pathfinding device according to claim 3, wherein
the one or more processors cause the pathfinding device to calculate an arrival time that is a time at which the electric vehicle arrives at the work node, and
the objective function is a sum of the outstanding work count, the total edge cost, and a total arrival time indicating a sum of the arrival times.

5. The pathfinding device according to claim 1, wherein
the one or more processors cause the pathfinding device to:
search for the path along which each of a plurality of the electric vehicles travels from the start point to the goal point; and
set a plurality of the charging nodes for one point at which the plurality of electric vehicles is charged, and
each of the charging nodes charges only one of the electric vehicles in a predetermined time slot, and the predetermined time slot of one of the charging nodes is a time slot different from the predetermined time slot of another of the charging nodes.

6. A server device in an information processing system including an electric vehicle and the server device configured to communicate with the electric vehicle, the server device comprising
the pathfinding device according to claim 1.

7. An electric vehicle comprising the pathfinding device according to claim 1.

8. A pathfinding method for searching for a path along which an electric vehicle travels from a start point to a goal point using a graph including a plurality of nodes representing points and edges representing partial paths connecting two of the points,
the pathfinding method being executed by one or more processors,
wherein
the plurality of nodes constituting the graph include a start node representing the start point, a goal node representing the goal point, a work node representing a point where work is performed, and a charging node representing a point where charging is performed for the electric vehicle, and
a required time required for the electric vehicle to travel from a start to an end of a partial path of the partial paths is associated with each of the edges constituting the graph,
the pathfinding method comprising:
acquiring the graph;
showing remaining battery power of the electric vehicle as a drivable time;
showing an amount of charging energy at the charging node as an increase in the drivable time;
setting an objective function that includes an outstanding work count indicating a total number of unused edges among the edges toward the work node included in the graph; and
among combinations of the edges of the graph used from the start node to the goal node, setting, as the path, a combination of the partial paths corresponding to a combination of the edges that minimizes a value of the objective function under a constraint that the drivable time during an entire period from the start node to the goal node is greater than or equal to zero.

9. The pathfinding method according to claim 8, wherein
the remaining battery power of the electric vehicle after the edges are used is indicated by subtracting the required times associated with the used edges from the drivable time.

10. The pathfinding method according to claim 8, wherein
the objective function is a sum of the outstanding work count and a total edge cost indicating a sum of the required times associated with the used edges.

11. The pathfinding method according to claim 10, further comprising
calculating an arrival time that is a time at which the electric vehicle arrives at the work node,
wherein the objective function is a sum of the outstanding work count, the total edge cost, and a total arrival time indicating a sum of the arrival times.

12. The pathfinding method according to claim 8, further comprising:
searching for the path along which each of a plurality of the electric vehicles travels from the start point to the goal point; and
setting a plurality of the charging nodes for one point at which the plurality of electric vehicles is charged, and
each of the charging nodes charges only one of the electric vehicles in a predetermined time slot, and the predetermined time slot of one of the charging nodes is a time slot different from the predetermined time slot of another of the charging nodes.

13. A computer-readable non-transitory storage medium storing a program for causing a computer to execute the pathfinding method according to claim 8.
